(19) United States
(12) Patent Application Publication
(10) Pub. No.: US 2010/0077557 A1
(43) Pub. Date: Apr. 1, 2010

(54) APPLICATION COMPOUND CONTAINING AND ADMINISTERING DEVICE

(76) Inventor: Francis Kiss deVirag, Kirtland Hills, OH (US)

Correspondence Address: TUROCY & WATSON, LLP, 127 Public Square, 57th Floor, Key Tower, CLEVELAND, OH, 44114, US

(21) Appl. No.: 12/566,314

(22) Filed: Sep. 24, 2009

Related U.S. Application Data
(60) Provisional application No. 61/229,296, filed on Jul. 29, 2009.
(60) Provisional application No. 61/099,714, filed on Sep. 24, 2008.

(51) Int. Cl. B08B 1/00

(52) U.S. Cl. 15/104.93

(57) ABSTRACT

An all purpose compound containing and administering device. The device allows for a sufficient amount of compound, and material required for administering the compound, to be stowed together in a portable and convenient kit. The device employs a compound component which contains an absorbent material saturated with a liquid compound or a shallow dish containing a solid compound. The compound component further employs an impermeable cover to prevent diffusion of the compound out of the compound component. The administering component can further contain an activator compound to activate the compound in the compound component. The device further includes a housing wherein the compound component is mounted on a first portion of the housing and the administering component is mounted on a second portion. The housing serves as a protective backing for the component of the device and/or a means to contain the device.

### CROSS-REFERENCE TO RELATED APPLICATIONS

This application claims the benefit of Provisional U.S. Patent Application Ser. No. 61/099,714 filed Sep. 24, 2008 and Provisional U.S. Patent Application Ser. No. 61/229,296 filed Jul. 29, 2009, the entirety of both of which are herein incorporated by reference.

### TECHNICAL FIELD

The present innovation generally relates to an all purpose compound containing and administering device. In particular, the present innovation relates to a portable device for containing a compound intended for the cleansing or polishing of objects or people, and the requisite material required to administer the compound. The innovation further relates to a portable device for containing lotions, cosmetics or medicated ointments and the requisite material required to administer the compound.

### BACKGROUND

Several compounds exist which are frequently used in our daily lives for cleaning, polishing, or removing substances from objects, textiles, or people. Similarly, people often use lotions, cosmetics, and medicated ointments. Many of the aforementioned compounds require a user to purchase a bottle or stock supply of the compound. Further, many of the compounds require a specific cloth, sponge, towel, or otherwise suitable material for applying and/or administering the compound. Therefore at any given time, a user must have access to both the stock of compound and the appropriate administering material in order to use the desired compound. However, several of the aforementioned compounds are required at times when a user is not home or does not have instant access to the compound or the material to administer the compound. For example, a user may stain a garment while away from home and may need to clean the garment right away.

The vast majority of garment stains occur while people are wearing such garments. The task of removing a stain from fabric is generally left to using a material that is convenient for the task. For proper stain removal the staining material needs to be actually removed, and not masked or hidden by chemical means. For example a red wine stain can be removed with seltzer water, applied to the stain while an absorbent material is placed behind the stain to absorb the red wine. The red wine is passed through the fabric by application of the seltzer water and by the proper action of patting the stain with a wet towel, which in turn passes the stain through to the dry blotter towel on the opposite surface.

There currently exists a stain removal pen type device that appears to be effective. However, the surfactant spoils and limits its useful life; and stains treated with the pen type device require further treatment after the fact to complete the process as this device does not actually remove the stain. There also exists a stain towel wipe for stains (US 2002/0174500 A1). Though partially effective, a towel wipe device lifts some of the stain but spreads and sets the remainder. There also exist two portable kits for removing a stain. One container carries a spray bottle containing a liquid and an absorbent material (U.S. Pat. No. 7,303,347 B1), and separate container for carrying stain removal tools such as a brush, a scraper, and a swab (WO 99/50494). The former aforementioned kit appears to be effective but requires a number of components to be carried on the person in at least two separate containers. The latter portable kit has four compartments within an elongated housing. Each compartment contains a sponge, or a sponge and an agent. Such kit also appears to be effective although removal of a stain takes four separate steps with four separate components. Every act of removing a stain requires several steps wherein the apparatus needs to undergo a conversion in order to expose the compartment with the appropriate sponge or sponge and agent. Therefore, most currently existing laundry pre-treatment devices limit the mobility, convenience, and proper method for removing stains when they first occur. The few portable stain removal kits that exist are unnecessarily complicated to use because they involve several steps that require additional time; and tools that must be cleaned, maintained, or replaced between uses thereby limiting their ease of use and convenience.

### SUMMARY

The following presents a simplified summary of the invention in order to provide a basic understanding of some aspects of the invention. This summary is not an extensive overview. It is intended to neither identify key or critical elements of nor delineate the scope of the invention. Its sole purpose is to present some concepts of the invention in a simplified form as a prelude to the more detailed description that is presented later.

The subject innovation encompasses a stain removal device designed to remove stains from a fabric by use of a wet applicator pad and a dry blotter pad. Stains to be removed can be either greasy, oil-based (e.g. cosmetics, grease, oil, spaghetti sauce) or water-based stains (e.g. blood, coffee, latex paint, soft drinks). Such stain removal device consists of both a sealed moistened applicator and a dry blotter capable of ‘wicking’ a stain through a fabric or garment by capillary action. The applicator and the blotter are enclosed together in a sealed packet wherein the pads are faced together or placed independently in the same sealed pouch.

The two pads are preferably mounted upon impermeable base sheets that can prevent flow-through onto the skin, and are enclosed together in one sealed packet. The wet applicator pad serves as a carrier for a stain removal liquid. The dry blotter pad serves as a recipient of such liquid and any stain passed through a fabric. The wet pad is sealed with a removable impermeable membrane separating it from the dry blotter pad; thus forming a sealed two part system that is easily stowed with the person, and easily disposed of after a single use.

The subject invention is a compound containing and administering device (CCAD). In a single portable and efficient unit, the device provides a compound used for the cleaning or polishing of objects or people and the requisite material for administering the compound. The device can further comprise lotions, cosmetics or topical medicines and the appropriate material for administering the compounds. The device employs two components, a compound component and a compound administering component. The compound component generally comprises of layer of absorbent material such as a sponge, which is saturated with a compound. The compound component can serve as a reservoir of compound and/or a means for applying the compound.

The administering component comprises of a material which is generally required to administer the specific cleaning or polishing compound, or cosmetic, lotion, or medicated ointment contained in the compound component. The material can include but is not limited to: a cloth, sponge, towel, wipe, or abrasive pad. In one embodiment the administering component consists solely of the dry material used to administer a compound. In another embodiment, the administering component can function to activate and administer the compound contained within the compound component. In such an alternative embodiment, the administering component comprises an activator compound integrated within the material either in a dry form, or a liquid or semi-liquid form whereby the activator compound is absorbed and/or contained within the administering material.

The compound component and the administering component are mounted upon a housing which provides a backing for the two components. The housing contains a first portion that supports the compound component and a second portion that supports the administering component. In one embodiment, the housing is an impermeable sheet of flexible plastic.

Prior to use, CCAD is provided in a closed form wherein the surfaces of the two components are touching and facing one another while the housing attributed to each component forms the outer shell of the device. The compound component and/or the administering component can be covered with a thin impermeable material to prevent the diffusion of the compound out of the material employed for each component, or to prevent the interaction between the compound contained in the compound component and the activator compound prior to use. The two portions of the housing and requisite components thereon are either connected, connected with the ability to separate, or separated. In a one embodiment, the two portions of the housing are connected in a manner which keeps the device in a closed form. Alternatively or in addition to the embodiment above, the device is contained within a sealed packaged in a closed form.

In order to use the device, the two portions are separated or partially separated such that the compound in the compound component can be extracted and the administering component can be utilized. The compound is extracted either by pressing the compound component directly onto an object in order to apply the compound or by utilizing the administering component to collect the compound. The administering component is then utilized to administer the compound such as to rub the compound onto an object or to absorb the compound applied to an object. When the administering component includes an activator compound, the compound component and the administering component are pressed together in order to mix the two compounds between the material of each component and then applying the mixed compound to an object with either component. Alternatively the compounds contained in each component are mixed as each component is applied to the surface of an object.

In one embodiment, the CCAD is a stain removal device designed to remove stains from textiles. In this embodiment, the compound component acts a wet applicator pad and consists of a sponge saturated with a detergent. The administering component counterpart is a dry absorbent material and acts as blotter pad. The two pads are mounted upon an impermeable housing material that can prevent flow-through onto the skin. The wet applicator pad serves as a reservoir for a stain removal liquid. The dry blotter pad serves as a recipient of such liquid and any stain passed through a fabric. The wet pad is sealed with a removable impermeable material separating it from the dry blotter pad.

The two portions of the housing are connected such that the housing folds in half along the area connecting the two portions. When in closed form, the entire surface of the compound component and the entire surface of the administering component are touching while the housing forms the outer shell of the device. The two portions are further separable. The device is either contained within a sealed packet or the housing is connected so as to keep the device in closed form prior to use. Upon the need for stain removal, the two pads are separated, the blotter is preferably placed on one side of the stained fabric and the sealed wet pad is opened then pressed upon the opposite side of the stained fabric. As the pads are pressed and/or rubbed together, the stain is loosened from the fabric and transferred to the recipient blotter pad on the reverse side.

The CCAD can employ the housing, compound component, and administering component in a form which allows for multiple uses of the device or in a form which causes the device to be disposable after a single use. Further, the device can be a variety of shapes, forms and sizes to enhance administration of the compound in relation to the function of the compound, and to facilitate portability. For example, the device can be rectangular or circular, rigid or flexible, and/or pocket sized. Further, when employing an impermeable material, the housing allows a user to administer a compound without coming into direct contact with the compound, providing a safe and sanitary means for administering compounds. The CCAD thus provides a convenient and efficient means for carrying out a variety of daily tasks requiring the application of compounds. In particular the device provides a portable means for cleaning and polishing objects.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 of the drawing is a graphic representation of an embodiment, including a dry blotter, liquid impermeable base sheet, removable liquid cover, and a wet applicator.

FIG. 2A depicts a high level illustration of a compound containing and compound administering device.

FIG. 2B illustrates another embodiment of a compound containing and administering device.

FIG. 3A illustrates an alternative embodiment of a compound containing and administering device.

FIG. 3B illustrates a compound containing and administering device and the manner in which the device achieves a closed form

FIG. 4A illustrates a side front view of a circular shaped compound containing and administering device.

FIG. 4B illustrates a cross section of a circular shaped compound containing and administering device.

FIG. 4C illustrates a circular shaped compound containing and administering device with the two portions of the device being separated.

FIG. 5A illustrates another embodiment of a compound containing and administering device.

FIG. 5B illustrates an enlarged compound component of a compound containing and administering device.

### DETAILED DESCRIPTION

Described is a simple, portable and disposable kit which contains both a compound and the material required to administer the compound. The kit allows the user to stow an appropriate amount of compound required to carry out a single cleaning, polishing or otherwise applicable activity and the requisite material to administer the compound. Further, the kit allows a user to administer a compound without coming into direct contact with the compound when the user is away from the convenience of a washroom or does not have protective gloves.

The subject innovation generally relates to a device for removing stains from fabric. In particular, the subject invention relates to the proper treatment and removal of stains from fabric, especially a garment. The subject device can easily be carried on the person and supplies a portion of stain removal liquid on an applicator pad as well as a dry blotter pad in the same sealed package. This allows the stain to be properly treated; by using the wet applicator to loosen the stain thereby facilitating passage through the fabric into the blotter, to be disposed of in the refuse thereafter. A garment in need of treatment can be worn at most, if not all, times during a treatment.

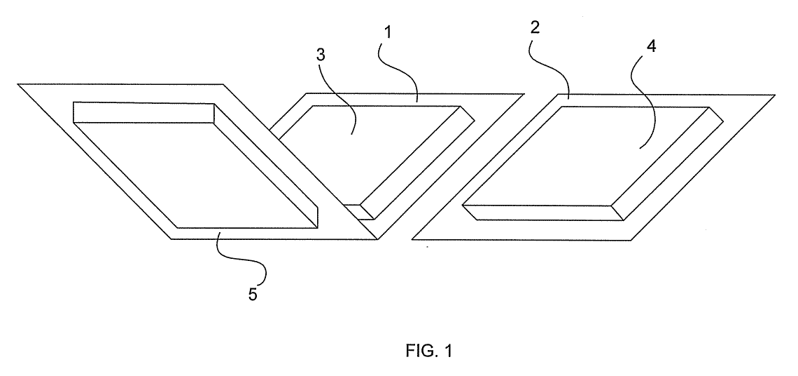

In one embodiment, FIG. 1 shows a perspective view of one version of a fabric stain blotter device. Impermeable base sheets 1 and 2 hold in-place the wet applicator pad 3 and dry blotter pad 4 respectively. The impermeable base sheet 1 and 2 prevent liquid stain or stain removal agent in wet applicator pad 3 from passing through the wet applicator pad 3 or dry blotter pad 4. Such feature also can prevent the stain from being transferred to anything but the dry blotter pad 4 and also prevents the user's skin from being exposed to a stain removal liquid.

To aid in keeping the wet applicator pad 3 from drying out and to preserve the stain removal liquid, there is a removable liquid proof cover or membrane 5. There is also sealed packet that allows the device to be carried on a person in one convenient leak proof container (not pictured in FIG. 1). To remove a stain the wet applicator pad and dry pad are removed from the leak proof container and sandwiched upon the stain. The wet applicator pad can be dabbed, pressed firmly, and/or scrubbed onto the stain thereby loosening the stain and allowing the stain and stain removal liquid to pass through the fabric, into the dry blotter pad on the opposite side.

The applicator pad 3 is a flexible and resilient cleansing pad that can be woven or non-woven and comprised of natural or polymeric fibers, or synthetic sponge. The synthetic sponge can be made of low-density polyether, polyvinyl alcohol, and/or polyester. In one embodiment, the applicator pad is from about 0.1 mm to about 10 mm in thickness and capable of holding and dispensing from about 1 mL to about 10 mL of a stain removal fluid comprised of an enzyme, a solvent, a surfactant, and/or water. In another embodiment, the applicator pad is from about 0.01 mm to about 20 mm in thickness and capable of holding and dispensing from about 0.1 mL to about 20 mL of a stain removal fluid. In yet another embodiment, the applicator pad is from about 0.5 mm to about 15 mm in thickness and capable of holding and dispensing from about 0.5 mL to about 15 mL of a stain removal fluid. Examples of enzymes include amylases and/or proteases; solvents can include alcohols or hyrdrotropes; and suitable surfactants should be ionic, non-ionic, and/or zwitterionic.

The applicator/cleaning pad 3 can be a monolayer or a multiple layer structure comprised of layers that can be perforated to facilitate scrubbing of heavily soiled fabrics as well as lifting particulate matter. The applicator cleansing layer contains a stain removal fluid, as it passes over the soiled surface such fluid interacts with the stain (and cleaning solution when used), loosening and emulsifying tough stains and permitting them to pass freely into the absorbent layer of the pad. The scrubbing layer can contain slits that provide an easy avenue for larger particulate stains to move freely into, becoming entrapped within the absorbent layer of the pad. Low density structures are preferred for use as the absorbent layer, to promote the transport of stain carrying fluid and particulate matter to the pad's absorbent layer.

The blotter pad 4 is a flexible and resilient absorbent pad that wicks a stain removal/carrier solution by capillary action and through a fabric (e.g. a garment). The blotter pad 4 can be woven or non-woven and can be comprised of natural or polymeric fibers, or synthetic sponge. The synthetic sponge can be made of low-density polyether, polyvinyl alcohol, and/or polyester. The blotter pad 4 is capable of ‘wicking’ and retaining a volume of stain and stain removal greater than or equal to the volume of fluid in the moist applicator pad, or up to about 10 mL at a controlled rate of fluid absorbency, which allows for beneficial cleaning without using large quantities of fluid.

Depending upon the pad, the polymeric type of the fibers can be hydrophilic or hydrophobic to influence the inherent absorbent properties of the pad. A hydrophilic fiber provides the capacity to absorb liquid via fiber imbibitions, giving rise to fiber swelling. It also attracts and retains a liquid external to the fiber in the capillaries and structure voids. A hydrophobic fiber usually repels a water-based liquid and can be used to effectively expel a stain removal solution onto a stained fabric. The properties of such fibers will be such that the applicator/cleaning pad exhibits the necessary stain fluid delay (wetting ability) and the blotter pad exhibits a complementary controlled rate of fluid absorbance. Suitable hydrophilic fibers for use in the subject innovation can be cellulosic, modified cellulosic fibers, rayon, and/or polyester fibers such as hydrophilic nylon.

An advantage of this embodiment is the addition of the dry blotter pad 4 that functions to remove the actual stain through the fabric garment rather than simply covering or hiding the stain. Moreover, by including the features in one leak proof container provides a convenient, disposable, leak proof, and highly portable device for properly removing stains when they first occur.

The present invention relates to an application compound containing and administering device (CCAD). The CCAD will now be described with reference to the drawings, wherein like reference numerals are used to refer to like elements throughout. It is to be appreciated that the various drawings are not drawn to scale from one figure to another nor inside a given figure, and in particular that the size of the components are arbitrarily drawn for facilitating the reading of the drawings.

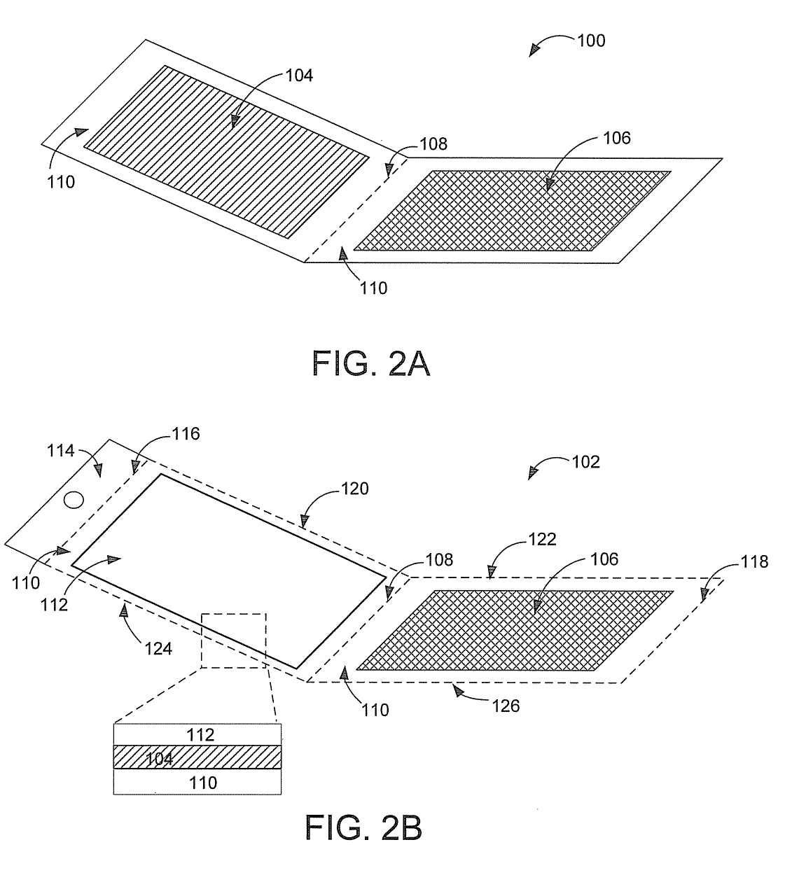

Although the various embodiments of a CCAD in FIGS. 2 to 5 are depicted in two dimensions, it should be understood that such a depiction merely facilitates clarity and that the components and aspects referred to herein are three dimensional. In the following description, for purposes of explanation, numerous specific details are set forth in order to provide a thorough understanding of the various embodiments and aspects of a CCAD. It may be evident, however, that the present invention may be practiced without these specific details. In other instances, well-known structures and devices are shown in block form in order to facilitate describing the present invention.

Referring to FIG. 2A, a high level illustration of a compound containing and administering device 100 is presented. The CCAD 100 employs a two part system whereby a compound and the appropriate element required to administer the compound is contained within a single apparatus. In general, the CCAD provides a compact, portable, and efficient means for cleaning, polishing, and/or applying a variety of compounds. Additionally, the CCAD allows a user to clean or polish an object, or otherwise administer a compound without coming into direct contact with the compound with the user's hands, thus allowing for a safe and sanitary mode of administering compounds.

Accordingly, the CCAD 100 contains an application compound component 104, an application compound administering component 106, and a housing 110. In one embodiment, the housing 110 connects the application compound 104 and the administering component 106 and independently serves to contain the device as a compact portable unit. The CCAD can further be contained within a sealed plastic pouch (not shown) for convenient portability and keeping of the device. The compound component 104 holds a variety of application compounds for cleaning and/or polishing including but not limited to: surfactants, detergents, fabric softeners, emulsifiers and emulsions, dispersants, foaming agents, and waxes. Additionally the compound component can hold lotions, medications, or cosmetics. It should be appreciated that any commercially available cleansing or polishing compound, lotion, medication or cosmetic, may be incorporated into the various aspects of the invention described herein.

The compound component 104 further provides a means for containing the application compound for efficient use and storage. When the application compound is in a liquid or semi-liquid state, the compound is integrated within an absorbent material which acts as a reservoir for the compound within the device 100. The reservoir material can further act as an applicator for the compound contained within. Accordingly, the reservoir material can be a monolayer or a multiple layer structure comprised of layers that can be perforated to facilitate cleaning. For example, the material can be a soft textured material used for scrubbing delicate surfaces while releasing a cleansing compound. The reservoir material can also include of a scrubbing layer, and an absorbent layer. The scrubbing layer can contain slits that provide an easy avenue for larger particulates to move freely into, becoming entrapped within the absorbent layer of the material.

The reservoir material is porous and water-permeable due to the flow of water and other aqueous compounds through the pores. A variety of absorbent materials can be employed as the reservoir material including but not limited to: various hydrophilic polymers, woven and nonwoven fabrics, cotton fabrics, rayon-cotton fabrics, cotton-like pulps, absorbent papers, open-celled foam, or synthetic sponges. The synthetic sponge can be made of low-density polyether, polyvinyl alcohol, and/or polyester. The pores in the reservoir material are large enough and frequent enough to permit the leakage and flow of the application compound through the material.

The amount of application compound provided within a particular CCAD device can vary depending on the type of compound, the absorption properties of the reservoir material employed, and the size of the reservoir material. In one embodiment the reservoir material is from about 0.1 to about 10 mm in thickness and capable of holding and dispensing liquid from about 0.1 to about 100 mL. The reservoir material and integrated application compound can be directly adhered to the housing 110. In another embodiment, an additional impermeable layer, such as a plastic film, can be employed between the reservoir material and the housing 110 so as to prevent diffusion of the application compound through the housing 110.

The compound component 104 can further include alternative means for the efficient use and storage of the application compound when the application compound is in a solid or semi-solid state. For example, application compounds such as lotions, cosmetics or waxes can be contained in a shallow dish (not show). The dish can be formed directly onto the housing 110 where the housing forms the base of the dish. Additional material can further be employed to construct a side barrier in order to contain the compound. The application compound within the dish can be exposed to the opposing surface or covered with a suitable lid or plastic film. In addition, the compound component can include a single compound and a single compound containing means or more than one compound and compound containing means. For example, a single compound component can comprise of a reservoir sponge with a cleansing compound and a shallow dish with a polishing compound. In another embodiment, the compound component can hold a cosmetic and a removing compound in the appropriate compound containing materials.

Referring back to FIG. 2A, the administering component 106 includes a material that can be utilized to administer the application compound contained in the device in consideration of the form and function of the compound. The compound component 104 and the administering component 106 for a specific device are designed as a complementary pair. Thus the specific material implemented as the administering component 106 is specifically tailored to administer the particular compound in the device. For example, if the application compound employed is a polishing wax, the reciprocal administering component can be a buffer pad. Further, the administering component can contain more than one administering material. For example, the administering component can employ a soft material for absorbing compound and an abrasive material for sanding down a surface prior to application of the compound.

Possible administering component materials that can be implemented in the device include pads, towels, wipes, papers, sponges or the like. The material can employ various hydrophilic polymers, various hydrophobic polymers, woven and nonwoven fabrics, cotton fabrics, rayon-cotton fabrics, cotton-like pulps, absorbent papers or open-celled foam. The administering component material can vary in absorbency and texture. It should be appreciated that any commercially available pads, towels, wipes, papers or sponges designed for cleaning, polishing, removing, or for applying lotions and cosmetics, can be implemented as the administering component 106 in accordance with the CCAD 100.

In one embodiment, the administering component contains of only dry material. In an alternative embodiment, the administering component contains a material and an activator compound. Several compounds exist which require mixing immediately before use in order to preserve the active time-life of the compound, improve the storage of the unmixed compounds or resulting compound, preserve safety, or enhance the properties of the resulting compound. The activator compound is integrated within the material in either a dry or liquid form. For example, US Patent Application 2007/0254824, incorporated herein by reference, describes several cleaning combinations comprising a liquid cleaning composition and a solid state catalyst separate from the liquid cleaning composition. The solid state catalyst causes a chemical reaction in the liquid cleaning composition when the liquid cleaning composition is brought into contact with the solid state catalyst. The chemical reaction between the compound and the catalyst alter or enhance the properties of the cleaning composition.

When in liquid form the administering component is similar to the embodiment of the compound component in which an absorbent material acts as a reservoir of compound. In this embodiment, the compound component and the application component are kept separated prior to use by employing a removable protective shield (not shown) covering one or both of the components. Upon use, the components are brought together in order to mix the compounds. Alternatively the compounds contained in each component are mixed as the components are applied to an object.

The administering component 106 can be permanently attached to the housing 110 or it can be detachable. For example, the administering component 106 can be a permanently attached sponge or a removable absorbent cloth. The removable cloth can be included within the device in a folded form and further expand to a larger size upon removal. In another embodiment where the administering component is an applicator sponge used in conjunction with a cosmetic, the sponge can be detached from the housing for use. When the administering component 106 is permanently attached to the housing 110, the material employed as the housing can complement the functional utility of the administering component 106. For example, the housing can be a flexible material when the administering component is a soft cloth intended to be used on surfaces with cracks and crevices.

Referring back to FIG. 2A, the CCAD includes a housing 110 with two portions wherein the compound component 104 and the administering component 106 are each mounted on one of the portions. The material employed for the housing 110 is designed to facilitate the function of the device. Suitable materials include durable paper, plastic, or durable fabric. Both portions of the housing 110 can employ a single material or each of the portions can be made of differing materials. For example, when used as polishing device, the portion of the housing containing the compound component can be a rigid plastic while the administering component can be a flexible fabric. Further, the portions can be the same in shape and size or have disparate shapes and sizes.

As depicted in FIG. 2A, the two portions of the housing 110 and requisite components contained thereon, are attached. In this embodiment the housing is designed such that the two portions are connected in a manner that allows the portions to fold on top of one another. Accordingly, the material employed as the housing 110 is a flexible material that can be bent or folded such that the two portions of the housing respectively constitute the two areas on the opposite sides of the folded divide. The housing material 110 can further have perforations along the folded divide to allow the material to fold easily. The perforations along the divide can also allow for the two portions to be manually separated. In another embodiment, the housing 110 is a hard plastic or metal case with the two portions connected by a joint mechanism. In this embodiment, the housing is similar to conventional containers used as make-up compact cases. Alternatively, the two portions of the housing can be completely separated and contained within a single sealed plastic pouch.

In FIG. 2A, the housing 110 folds along line 108 and allows the portion comprising the compound component 104 and the portion comprising the compound administering component 106 to touch such that the entire surface area of the compound component 104 is adjacent to the entire surface area of the administering component 106. In other words, the housing 110 opens and closes like a book wherein the compound component 104 and administering component 106 resemble opposite inner surfaces of the book and the housing 110 resembles the book's outer cover. When the entire surface area of the compound component 104 is adjacent to the entire surface area of the administering component 106, the CCAD 100 is in closed form. Regardless of the form in which the housing is provided, the CCAD device takes on a closed state prior to use. For example, when the two portions of the device are completely separated, they are contained within a sealed pouch in closed form. Accordingly, the size of the device is reduced and the inner components of the device are protected. Upon use, the two portions of the device are either separated or partially separated such that the device is in an opened form.

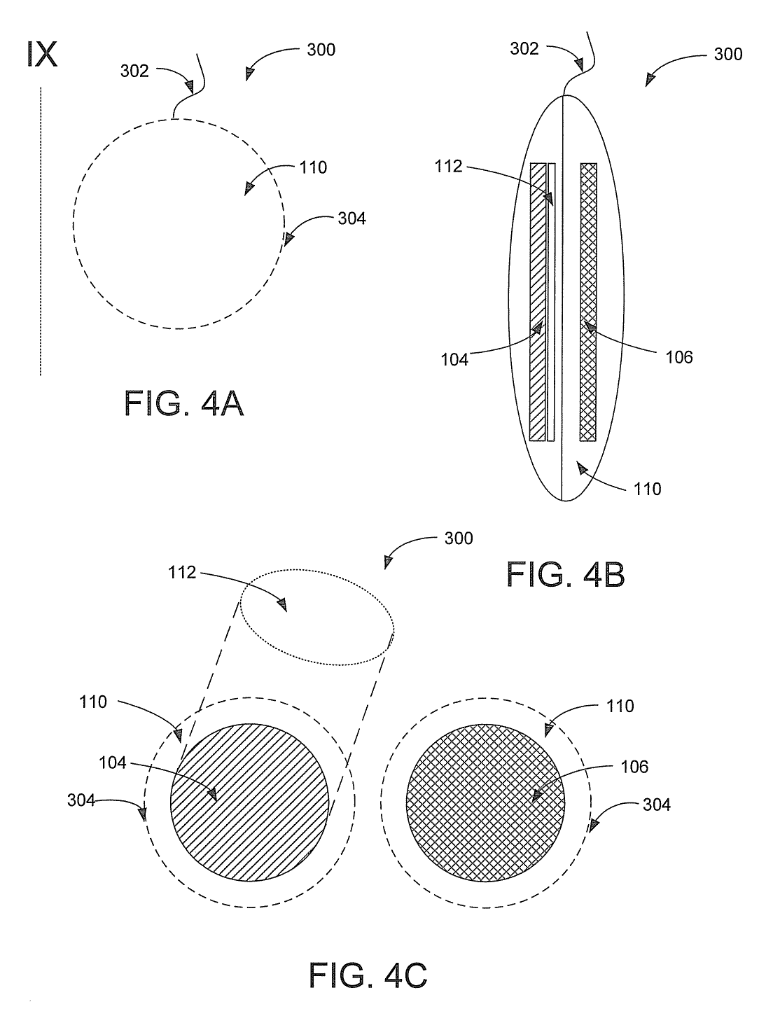

Referring back to the drawings, although the device in FIG. 2A has a rectangle shape, it should be appreciated that the CCAD can be designed in a variety of shapes and sizes in order to enhance the application of a particular compound in consideration of the prospective uses of the compound. For example, FIG. 4B presents an embodiment wherein the device is circular. Regardless of the shape of the device, the housing 110 allows the CCAD device to achieve an open and closed form. Further, although the two portions of the device in FIG. 2A are connected along the length of the sides of each of the device portions, the two portions can be connected in a variety of manners. For example, the portion comprising the compound component 104 and the portion comprising the administering component 106 can be connected along: a side or sides, the entire perimeter of each portion, a corner, or a single point.

The CCAD 100 can be tailored to perform a variety of functions. In one embodiment, the device is can be used a portable cleaning or polishing device for a variety of surfaces. For example, the device can be used to clean or polish furniture, countertops, stainless steel objects, silver, china, tires or glass. In this embodiment, the compound component 104 can comprise a reservoir material such as a sponge that is saturated with an appropriate cleaning or polishing compound and the administering component 106 can comprise of a cloth or sponge appropriate for the cleaning an object associated with the application compound employed. For example, the device can be designed to polish silver where the compound is an appropriate polish and the administering component is a soft cloth. The device can be designed to clean car tires where the compound is Amorall and the administering component is a dry wipe.

The CCAD 100 can also comprise a wax or a polish as the application compound and a buffer pad as the administering component 106. In this embodiment, the device can be used to polish the exterior of a car or wood furniture. The device can further function to remove gum, adhesives, wax, oil, glue, grease, or tar where the application compound is an appropriate removing compound, such as Goof-off, and the administering component is a material with an abrasive texture. Additionally, the device can be used to apply cleansers, lotions, medicines or cosmetics on people. For example, the application compound can be used in conjunction with baby lotion and an appropriate wipe. In another embodiment, the device can employ acne medication or concealer as the application compound and a sponge as the administering component 106.

In one embodiment, the CCAD device 100 is implemented as a device for removing stains from textiles. In this embodiment, the compound component 104 consists of a reservoir material saturated with a stain removing compound. The stain removing compound comprises of an enzyme, a solvent, a surfactant, and/or water. Suitable enzymes can include amylases and/or proteases; solvents can include alcohols or hyrdrotropes; and suitable surfactants should be ionic, non-ionic, and/or zwitterionic. The reservoir material preferably comprises of low density structures so as to promote the transport of stain carrying fluid and particulate matter into the material in addition to merely supplying the stain removing compound. The reservoir material can further comprise of a layer of textured material for scrubbing tough stains out of fabrics.

The administering component 106 is a flexible and resilient dry absorbent pad that wicks a stain removal/carrier solution by capillary action and through a fabric (e.g. a garment). The pad can be woven or non-woven and can be comprised of natural or polymeric fibers, or synthetic sponge. The synthetic sponge can be made of low-density polyether, polyvinyl alcohol, and/or polyester. The pad is capable of ‘wicking’ and retaining a volume of stain and stain removal greater than or equal to the volume of fluid in the reservoir material or up to about 25 mL or about 10 mL at a controlled rate of fluid absorbency, which allows for beneficial cleaning without using large quantities of fluid.

Depending upon the pad, the polymeric type of the fibers can be hydrophilic or hydrophobic to influence the inherent absorbent properties of the pad. A hydrophilic fiber provides the capacity to absorb liquid via fiber imbibitions, giving rise to fiber swelling. It also attracts and retains a liquid external to the fiber in the capillaries and structure voids. A hydrophobic fiber usually repels a water-based liquid and can be used to effectively expel a stain removal solution onto a stained fabric. The properties of such fibers will be such that the reservoir material exhibits the necessary stain fluid delay (wetting ability) and the administering pad 106 exhibits a complementary controlled rate of fluid absorbance. Suitable hydrophilic fibers for use in the subject innovation can be cellulosic, modified cellulosic fibers, rayon, and/or polyester fibers such as hydrophilic nylon. Further, the housing 110 employed is preferably made of an impermeable material such as a durable flexible plastic. Alternatively, the housing 110 can be a fabric or cardboard with a thin impermeable layer or coating between the housing and components mounted thereon.

The CCAD device is used to remove stains by laying a piece of stained fabric in between the portion of the device comprising the compound component 104 and the portion of the device comprising the administering component 106 when the device is open. The two portions are then brought together to sandwich the fabric as the device is manually pressed into a closed form. As the compound component 104 is pressed against the fabric and opposing dry pad 106 the detergent in the compound component is squeezed out of the reservoir sponge. In turn, the detergent soaks through the stained fabric, lifts the stain particulates, and then diffuses into the dry pad of the administering component 106 and into the absorbent pores of the reservoir sponge. Variations of the stain removing device can employ any type of detergent or compound capable of cleansing textiles. Further, a particular stain removing device can be tailored to a particular type of fabric or stain.

For example, a stain removing device can employ a detergent specific for colored fabrics, white fabrics, delicate fabrics, or durable fabrics. In another example, the stain removing device can employ a compound for removing grease stains, wine stains, or ink stains. The material employed as the administering component 106 can further be tailored to compliment a particular detergent or fabric type.

The cleaning, polishing, and other functions of the CCAD 100 described infra present only a few examples in which the device can be utilized. It should be appreciated that the device can be designed to contain and administer a wide range of similar cleaning, polishing, or cosmetic compounds for a variety of objects and surfaces. The size and shape of the device and the materials employed as the compound component 104, the administering component 106, and the housing 110 are tailored to the function of the device. In one embodiment, the device is designed to be about pocket size or smaller to make for a convenient and portable cleaning device. Similarly, the device can be designed to fit onto a keychain or comfortably in a small purse. In another embodiment, the device can be larger to allow for the incorporation of a greater amount of application compound within the reservoir material of the compound component 104.

Further, the size and shape of the compound component 104 and/or the administering component 106 can vary. As depicted in FIG. 2A, the compound component 104 and the administering component 106 are shaped similarly to the housing 110 with slightly smaller dimensions. However, the application component 104 and the administering component 106 can be disparate sizes, cover only a small portion of the housing 110 or extend the entire surface area of the housing. Furthermore, the CCAD device can be single use/disposable, or the device can allow for multiple uses. Accordingly, the CCAD device can be made of materials that are environmentally safe and/or biodegradable.

Referring now to FIG. 2B, presented is another embodiment of a CCAD 102 with additional features over the device 100 of FIG. 2A. In this embodiment the compound component is covered by an impermeable shield 112. The shield 112 functions to prevent the diffusion of an application compound out of the compound component where the application compound is contained within an absorbent material in a liquid or semi-liquid. For example, when the compound component employs a sponge saturated with a liquid detergent, a shield covering the compound component prevents the detergent from diffusing into the dry sponge of the opposing administering component 106 when the device is in closed form. The shield 112 can be made of a plastic in the form of a thin sheet or film, or any other durable material capable of protecting the administering component 106 from contamination with the compound contained in the compound component 104. The shield 112 can loosely cover the compound component or attach to the housing in order to seal the compound component. The shield 112 can thus also function to preserve the compound within the compound component 104.

Although not depicted, a similar shield can also be employed over the administering component 106 when the administering component comprises of an activator compound. Accordingly, the shield can serve to preserve the activator compound while further preventing the mixing of the compound contained within the compound component and the activator compound prior to use.

The CCAD 102 is further depicted with a dashed line around the perimeter of the two portions of the housing 110. The dashes line represents perforated attachment areas of the housing 110 as described below. In this embodiment the housing is a flexible plastic or cardboard which folds along the joint line 108 in order to create the two portions of the housing 110. When the device is in closed form, the two portions of the housing are attached along the entire perimeter of each portion. In particular, when the device is in closed form line segments 116 and 118 connect, line segments 120 and 122, and line segments 24 and 126 connect.

Prior to use, the CCAD is packaged in closed form. In order to open the device, the two portions are separated by pulling apart the portions along the perforated attachment points. The two portions can become completely separated or user may leave the two portions connected along the joint line 108. Alternatively, the two portions of the device can be made inseparable along the joint line. Further, in this embodiment, the housing 110 includes an extended piece of material 114.

The extended material serves to function as a strip of material that can be torn off of the housing along the perforated line 116 in order to initiate the separation of the two portions of the device along line 116. The extended material 114 can be the same material as the housing material 110 or it can be made of a different material.

The extended material 114 can further be a durable or rigid material that can be utilized as a scrapper upon separation from the housing 110. For example, when the device is used as an adhesive removing device, the extended material 114 can be made of a rigid plastic with a sharp edge. Upon separation from the housing 110, the extended material 114 can be used to scrape adhesive off of a surface prior to administering the removing compound in the device. In addition, the extended material 114 can employ a hole for hanging on a rack.

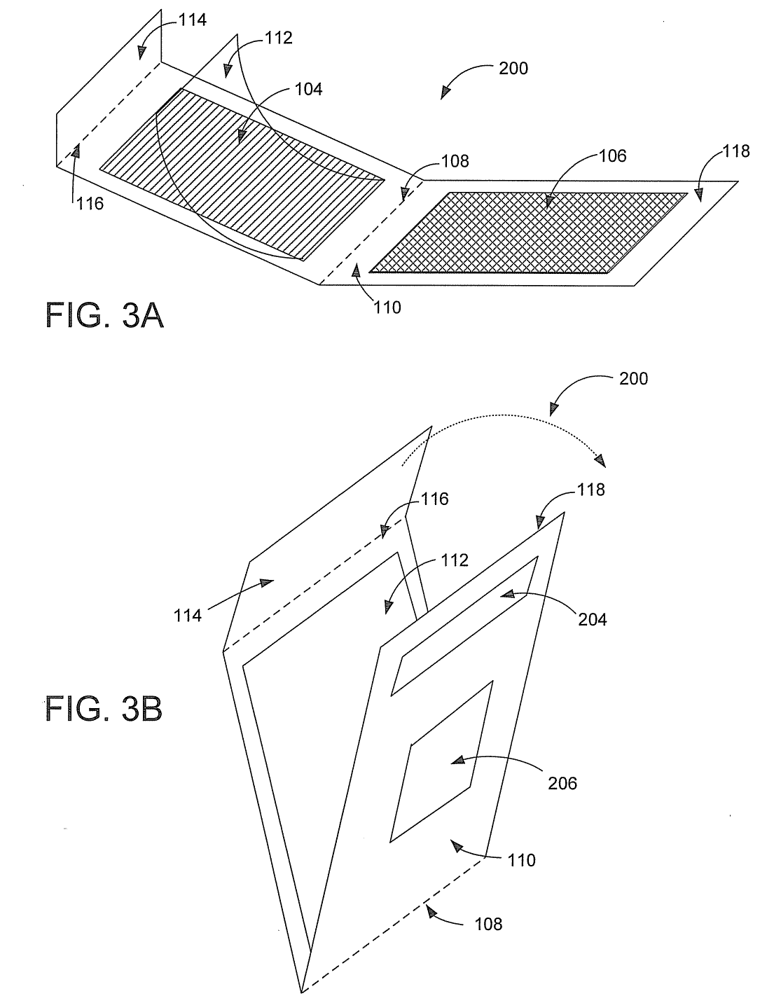

Looking now at FIG. 3A, depicted is another embodiment of a CCAD 200. Shown at 112 is a thin plastic shield lifted away from the compound component 104. The two portions of the device are connected along the joint 108. Further, the device comprises an extended portion of material connected along edge 116. The dashed lines demonstrate areas where parts of the device are separable. In this embodiment, the extended material of the housing 114 acts a flap which folds over the housing of the device. When the device is in closed form, the flap connects to the outside of the housing on the opposite portion of the device in order to close the device. The flap 114 thus acts as a piece to attach the two portion of the device at the top of the device. The extended material/flap 114 can further be detached from the device and utilized as a scraper. The manner in which CCAD device is closed and the manner by which the two portions of the device are attached is further depicted by FIG. 3B.

In FIG. 3B, the extended material 114 folds over the housing 110 in the direction of the dotted arrow, and attaches to the housing along area 204. The flap 114 can attach by way of an adhesive, a hook, Velcro, or the like. When the flap 114 is attached to the outer surface of the housing at area 204, the device is in closed form. In this embodiment, the device is connected at the top and the bottom, however the sides of the devise remain unattached. This embodiment allows for the device to employ a thick compound component and/or a thick administering component. Further, the flap 114 can function to open and close the device repeatedly. Thus the device 200 can be re-closed after being opened and utilized. As such, the CCAD 200 can employ sufficient amount of compound so that it can be used more than one time. Further, the device can be disposed of after use in a closed form whereby the remaining contents of the device and the debris gathered by the device, are disposed of in a sanitary manner.

Further, the outer portion of the housing can comprise of a textured area or a gripping component 206. The gripping component can be a hook, handle or rubber gripper located on any outer area of the housing 110. For example, a gripping component can be located on the outer side of the housing on each of the portions of the housing. The gripping component 205 can further facilitate the ease of use of the device.

Referring now to FIGS. 4A to 4C, depicted are three viewpoints of another embodiment of a CCAD 300. FIG. 4A shows a topical viewpoint of a circular shaped device in closed form. Shown in FIG. 4A is the outer side of the housing 110 for one portion of the device. The second portion of the device housing (not shown) is directly behind the visible portion of the device housing 110. The two portions are connected along the entire circumferential edge of each portion of the housing, depicted in FIG. 4A as dashed line 304. Edge 304 is a perforated portion of the housing which can be broken in order to separate the two portions of the device in order to open the device. In one embodiment, the two portions are separated by pulling a string 402 which is integrated within the perforated edge 304 and extends the entire circumference of the device housing along edge 304.

FIG. 4B presents a cross sectional view of the CCAD 300 along axis IX. The device employs two portions wherein one portion contains the compound component 104 and the other portion contains the administering component 106. The compound component is further covered by a thin plastic shield 112. The housing 110 can be any material capable of employing a perforated edge that can be separated by an integrated string 302. FIG. 4C shows the CCAD 300 in open form. As seen in FIG. 4C, the two portions of the device are completely separated when the device is opened. In an alternative embodiment, the two portions of the device can be completely separated when stored in closed form and contained within a sealed packet. In order to utilize the device, a user merely opens the packet and removes the components of the device.

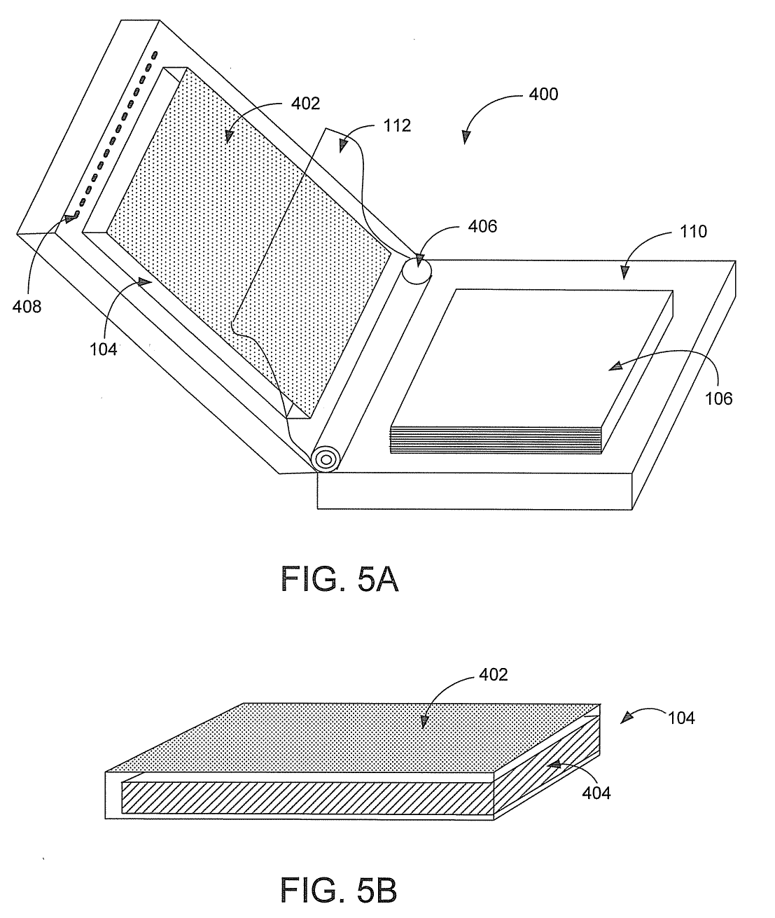

Referring now to FIGS. 5A and 5B, presented is an embodiment of a CCAD 400 employing a sturdy plastic or metal case for a housing 110. The case opens and closes via a joint mechanism and can employ any suitable mechanism to snap or lock the two components of the case together. In this embodiment, the device is intended to be used several times. FIG. 5B depicts an enlarged view of the compound component 104. The compound component contains a sponge or other absorbent material 404 saturated with a compound. The saturated material 404 is further contained within a shallow dish which comprises of a lid or cover 402 made of a flexible plastic. The lid 402 employs several holes or slits which allow the compound to seep through when pressed against the saturated material 404 located directly below it. In this arrangement a large amount of compound can be contained within the compound component and the release rate of the compound can be controlled. Alternatively, the compound component can employ any combination of the embodiments described infra.

In addition, the administering component 106 is designed to allow for multiple uses. As depicted in FIG. 5A, the administering component 106 contains several layers of an absorbent cloth or paper which can be torn off and discarded following each use. The CCAD device further comprises of a shield component 112 such as a thin plastic film over the compound component. In order to provide convenient and efficient removal and storage of the shield component 112 during use, the device can employ simple a pulley system 406 consisting of a small tube in which the plastic shield 112 can wrap around. The pulley system can allow the shield 112 to be pulled up to cover the compound component 104 and attach to the housing above the compound component 408 by way of a hook, adhesive, magnet, Velcro, or other suitable mechanism. The pulley system 406 can also employ a spring which allows the shield to easily retract into the pulley. When closed or not in use, the shield 112 can cover the compound component 104. Further, the device can allow the shield 112 to automatically retract into the pulley 406 when the device is opened. In another embodiment, the shield is simple film or plastic capable of being removed from the compound component during use and then reattached for storage.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

What has been described above includes exemplary implementations of the present innovation. It is, of course, not possible to describe every conceivable combination of components or methodologies for purposes of describing the present innovation, but one of ordinary skill in the art will recognize that many further combinations and permutations of the present innovation are possible. Accordingly, the present innovation is intended to embrace all such alterations, modifications and variations that fall within the spirit and scope of the appended claims.

What is claimed is:

1. A compound containing and administering device comprising:
a compound component comprising one or more compounds intended for application upon objects or people wherein the compound is contained within a shallow receptacle when in a solid state or within an absorbent material when in a liquid state, the absorbent material acting as both a reservoir of compound and a pad for applying the compound;
an administering component comprising one or more administering materials that are necessary to administer the intended use of a compound contained within the compound component; and
a housing which comprises a first portion whereon the compound component is mounted and a second portion whereon the administering component is mounted; the housing serves as at least one of a protective backing for the components thereon or a shell that holds the compound component and the administering component together prior to use.

2. The device of claim 1 wherein a compound is a compound used for the cleaning, or polishing of hard surfaces or textiles and includes at least one of: a surfactant, a detergent, a solvent, a fabric softener, an emulsifier, emulsions, a dispersant, a foaming agent, or a wax.

3. The device of claim 1 wherein a compound is a soap, lotion, medication or cosmetic intended for application on people.

4. The device of claim 1 wherein the absorbent material is a porous material from about 0.1 mm to about 10 mm in thickness, carries from about 1 mL to about 10 mL of liquid compound and comprises at least one of: hydrophilic polymers, woven and nonwoven fabrics, cotton fabrics, rayon-cotton fabrics, cotton-like pulps, absorbent papers, open-celled foam, or synthetic sponges.

5. The device of claim 4 wherein absorbent material is a synthetic sponge saturated with a compound for removing stains from textiles.

6. The device of claim 1 wherein the absorbent material comprises a single layer or multiple layers, wherein a layer comprises material which is at least one of soft, abrasive, highly absorbent, or predominately hydrophobic; and wherein multiple layers comprise similar or dissimilar material.

7. The device of claim 1, wherein the compound component further comprises a removable cover in order to prevent the diffusion of a liquid compound contained with the absorbent material prior to use of the device; the removable cover is comprised of a thin plastic, foil, or impermeable membrane.

8. The device of claim 1 wherein an administering material is a pad, towel, wipe, or sponge and comprises: various hydrophilic polymers, various hydrophobic polymers, woven and nonwoven fabrics, cotton fabrics, rayon-cotton fabrics, cotton-like pulps, absorbent papers or open-celled foam.

9. The device of claim 5 wherein an administering material is a porous woven or non-woven material in the form of a dry blotter pad;
the dry blotter pad is capable of lifting a stain from textiles by capillary action;
the dry blotter pad is from about 0.1 to about 10 mm thick; and
the dry blotter pad can absorb and retain a volume of a stain removal compound at least equal to about 10 mL.

10. The device of claim 1 wherein the housing comprises of a flexible and impermeable material including: plastic, durable fabric or durable paper, wherein the fabric or paper is coated with a sealant.

11. The device of claim 10, the housing further comprising a detachable extension of material which is utilized as at least one of: a scrapper for removing debris from an object, a flap for connecting the first and second portions of the housing, or a means for separating the first portion and second portion of the housing upon detachment.

12. The device of claim 1 wherein the first portion of the housing and the second portion of the housing are made of the same material or differing materials.

13. The device of claim 1, wherein the two portions of the housing and are connected in a manner which keeps the device in a closed form, a closed form being established when the entire surfaces of the compound component and the administering component are touching and facing one another while the housing attributed to each component forms an outer shell of the device.

14. The device of claim 13 wherein the first portion of the housing and the second portion of the housing are connected along one or more sides or corners of each portion, and wherein the area of the housing connecting the first portion and second portion is perforated such that the first portion and second portions are manually separable.

15. The device of claim 1 wherein the housing is a hard plastic or metal, and where the first portion of the housing and the second portion of the housing are connected by a joint mechanism.

16. The device of claim 1 wherein the device is contained within a sealed packaged in a closed form, and wherein a closed form is established when the entire surfaces of the compound component and the administering component are touching and facing one another while the housing attributed to each component forms an outer shell of the device.

17. The device of claim 1 further comprising an activation compound integrated within an administering material, the activation compound serving to activate, enhance or alter the properties of the compound contained within the compound component when the two compounds interact; and wherein the administering component comprises a removable cover made of a thin plastic, foil, or impermeable membrane that prevents the activation compound from diffusing out of the administering material.

18. A method for containing a compound and the requisite component to administer the compound in a single portable unit comprising:
employing a compound component comprising one or more compounds intended for application upon objects or people wherein the compound is contained within a shallow receptacle when in a solid state or within an absorbent material when in a liquid state, the absorbent material acting as both a reservoir of compound and a pad for applying the compound;
providing a removable, impermeable cover over the absorbent material to prevent the diffusion of the compound;
employing an administering component comprising the material required for administering the intended use of the compound;
providing a protective housing and mounting the compound component upon a first portion of the housing and mounting the administering component on a second portion of the housing; and
connecting the first portion of the housing and the second portion of the housing in a manner wherein the entire surfaces of the compound component and the administering component are touching and facing one another while the housing attributed to each component forms an outer shell of the device; or
containing the compound component, administering component, and the housing attributed to each component, in a sealed pouch.

19. A method for applying and administering a cleansing compound with a single device comprising:
providing a compound component comprising one or more liquid or semi-liquid compounds intended for application upon objects or people wherein the compound is contained absorbent material in the form of a flexible pad;
providing a removable, impermeable cover over the compound component to prevent the diffusion of the compound prior to use;
providing an administering component comprising the material required to administer the compound according to its intended use;
protecting the direct contact of the user with the compound and cleansing surface by fixing the compound component and the administering component to a flexible impermeable backing; and
containing the compound component, administering component, and the backing attributed to each component, in a sealed pouch.

20. The method of claim 19 further comprising:
opening the sealed pouch to separate the compound component from the administering component;
removing the cover from the compound component and pressing, squeezing, rubbing or scrubbing an object, person, or the administering material with the compound component;
utilizing the administering component to wipe, blot, pat, dry, scrub, or spread the compound on the object or person; and
disposing of the compound component and administering component.
